(19) United States
(12) Patent Application Publication
(10) Pub. No.: US 2012/0164893 A1
(43) Pub. Date: Jun. 28, 2012

(54) ELECTRIC CONTACT AND CONNECTOR USING THE SAME

(75) Inventors: Shigeru Mitsuzuka, Kanagawa (JP); Toru Takane, Kanagawa (JP)

(73) Assignee: IRISO ELECTRONICS CO., LTD., Kanagawa (JP)

(21) Appl. No.: 13/061,276

(22) PCT Filed: Jul. 6, 2009
(86) PCT No.: PCT/JP09/62307

§ 371 Date: Mar. 19, 2012

(30) Foreign Application Priority Data
Aug. 27, 2008 (JP) 2008-218019

(51) Int. Cl. H01R 13/05

(52) U.S. Cl. 439/692; 439/891

(57) ABSTRACT

When a male side contact is inserted into a female side contact, female side contact portions in the female side contact press a plurality of male side contact portions in the male side contact, and each of the male side contact portions is displaced in a thickness direction of the male side contact while contacting the female side contact portions so that a contact area between the contacts can be sufficiently ensured. When the contacts are connected to each other, a feeling of the female side contact portions, together with each of the male side contact portions, being displaced in the thickness direction of the male side contact can be obtained. Further, the contacts engage with each other by the displacement of each of the contact portions so that movement of the male side contact in a direction opposite to its insertion direction can be regulated.

### RELATED APPLICATIONS

The present application is a U.S. National Phase of International Application Number PCT/JP2009/062307, filed Jul. 6, 2009, and claims priority from Japanese Application Number 2008-218019, filed Aug. 27, 2008.

### TECHNICAL FIELD

One of more embodiments of the present invention relate to an electric contact used for power supply wiring for an automobile or the like, for example, and a connector using the same.

### BACKGROUND ART

A conventionally known connector of this type includes a plug having a male side contact and a socket having a female side contact and is adapted to fit the plug into the socket so that the male side contact and the female side contact are in a conductive state (see, e.g., Japanese Patent Publication 2001-176592).

### SUMMARY OF INVENTION

### Technical Problem

In the connector, an inner peripheral surface of a cylindrical female side contact is brought into contact with an outer peripheral surface of a pin-shaped male side contact. When thus brought into contact with each other, however, the contacts are difficult to reliably bring into surface contact with each other. The contacts may often be partially brought into point contact with each other. Therefore, a contact area between the contacts is decreased. If the connector is used with a high current of 30 A or more, for example, the current collects at their contact point so that heat is easily generated. The connector, therefore, is not suitable for a high-current connector. In the connector, the male side contact is formed so as to be elastically deformable in its radial direction, to apply moderate contact pressure to the female side contact. However, the female side contact is subjected to equal contact pressure at any insertion position of the male side contact. Therefore, it is not easily confirmed whether the male side contact is inserted into a proper position of the female side contact, and the male side contact is insufficiently prevented from being removed in a direction opposite to its insertion direction.

One or more embodiments of the present invention have been made in view of the above-mentioned problems, and are directed to providing an electric contact in which a contact area between contacts can be sufficiently ensured, a proper insertion position can be easily confirmed, and/or connection is not easily released, and/or a connector using the same.

### Solution to Problem

In order to attain one or more of the above-mentioned objects, an electric contact having a male side contact and a female side contact and adapted to make a connection between the male side contact and the female side contact in a conductive state by inserting the male side contact into the female side contact in its longitudinal direction includes a plurality of male side contact portions each provided at a predetermined position in the longitudinal direction of the male side contact so as to be deformable in a direction perpendicular to the longitudinal direction of the male side contact and arranged so that their contact positions with the female side contact are the same in the longitudinal direction of the male side contact, and a female side contact portion provided in the female side contact so as to be elastically deformable in a direction perpendicular to the longitudinal direction of the male side contact and extending in a direction in which the male side contact portions are arranged, in which when the male side contact is inserted into the female side contact, each of the male side contact portions is displaced in the direction perpendicular to the longitudinal direction of the male side contact upon being pressed by the female side contact portion.

In order to attain one or more of the above-mentioned objects, the present invention includes the electric contact in the connector.

When the male side contact is inserted into the female side contact, therefore, the female side contact portion in the female side contact presses the plurality of male side contact portions in the male side contact, and each of the male side contact portions is displaced in a direction perpendicular to the longitudinal direction of the male side contact while contacting the female side contact portion. Therefore, a contact area between the contacts can be sufficiently ensured. When the contacts are connected to each other, a feeling of the female side contact portion, together with each of the male side contact portions, being displaced in a direction perpendicular to the longitudinal direction of the male side contact can be obtained. Further, the contacts engage with each other by the displacement of each of the contact portions so that movement of the male side contact in a direction opposite to its insertion direction is regulated.

### Advantageous Effects of Invention

According to one or more embodiments of the present invention, a sufficient contact area between a male side contact and a female side contact can be ensured. Even when an electric contact is used with a high current, therefore, the male side contact and the female side contact can reliably be maintained in a conductive state without generating heat at their contact point. When the contacts are connected to each other, a feeling of a female side contact portion, together with each of male side contact portions, being displaced in a direction perpendicular to a longitudinal direction of the male side contact can be obtained. It can be easily confirmed that the male side contact has been inserted into a proper position of the female side contact so that the contacts can be effectively prevented from being poorly connected to each other due to insufficient insertion. Further, movement of the male side contact in a direction opposite to its insertion direction can be regulated by engagement between the contacts. Therefore, the connection between the contacts is not easily released, and connection reliability therebetween can also be improved.

### BRIEF DESCRIPTION OF DRAWINGS

FIG. 1 is a perspective view of an electric contact according to a first embodiment of the present invention.

FIG. 2 is an exploded perspective view of a male side contact.

FIG. 3 is a side view of a principal part illustrating a connection process in an electric contact.

FIG. 4 is a perspective view of an electric contact according to a second embodiment of the present invention.

FIG. 5 is an exploded perspective view of a male side contact.

FIG. 6 is a plan view of a female side contact.

FIG. 7 is a side sectional view of a principal part illustrating a connection process in an electric contact.

FIG. 8 is a perspective view of a plug for connector including an electric contact according to the present invention.

FIG. 9 is a front view of a plug.

FIG. 10 is a perspective view of a socket for connector including an electric contact according to the present invention.

FIG. 11 is a side sectional view of a socket.

### DESCRIPTION OF EMBODIMENTS

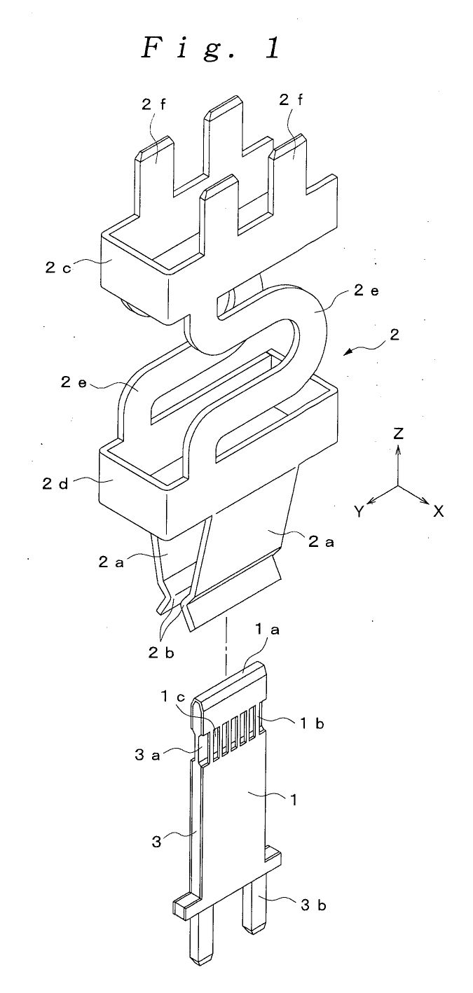

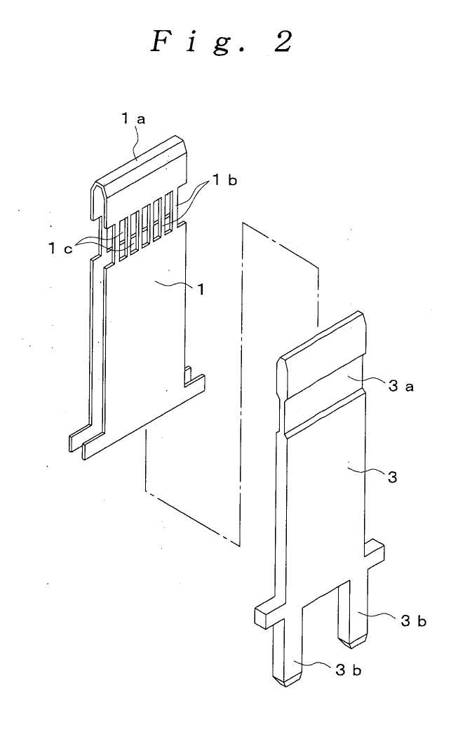

FIGS. 1 to 3 illustrate a first embodiment of the present invention.

An electric contact in the figures includes a male side contact 1 formed into a flat shape, a female side contact 2 connected to the male side contact 1, and an inside member 3 arranged inside the male side contact 1, and is used for a high-current connector, for example.

The male side contact 1 is formed into a hollow shape by folding a conductive metal plate so that both its ends oppose each other, and has an end 1a (folded portion) having a tapered shape. A plurality of male side contact portions 1b, which contacts the female side contact 2, is each provided at a predetermined position in a longitudinal direction at the one end of the male side contact 1, and the male side contact portions 1b are arranged in a direction in which their contact positions with the female side contact 2 are the same in the longitudinal direction of the male side contact 1 (a width direction of the male side contact 1). The male side contact portions 1b are provided among a plurality of long holes 1c extending in the longitudinal direction of the male side contact, and are formed into a strip shape that is deformable in a direction perpendicular to the longitudinal direction of the male side contact 1 (a thickness direction of the male side contact 1).

The female side contact 2 is formed by folding a conductive metal plate, and has a pair of elastic pieces 2a, which is elastically deformable in the thickness direction of the male side contact 1, provided at an end. Each of the elastic pieces 2a is made wider than the male side contact 1. The pair of elastic pieces 2a has a pair of female side contact portions 2b, which contacts the male side contact 1, provided at its leading end. The female side contact portions 2b project toward the inside of the elastic pieces 2a so as to oppose each other, and extend in a direction in which the male side contact portions 1b are arranged (a width direction of the elastic pieces 2a). The female side contact 2 includes a fixed portion 2c formed at the other end and a movable portion 2d provided with the elastic pieces 2a. A pair of elastic portions 2e bent in a U shape is provided in parallel with each other between the fixed portion 2c and the movable portion 2d. The fixed portion 2c is folded in a Π shape to extend from the one end to the other end in a width direction of the female side contact 2, and has a plurality of connection portions 2f arranged to be connected to an object to be energized. The movable portion 2d is formed into a square cylindrical shape of a similar size to that of the fixed portion 2c, and is spaced apart from the fixed portion 2c in the longitudinal direction of the male side contact 1. The elastic portions 2e oppose each other in the thickness direction of the male side contact 1, and the movable portion 2d is elastically deformed so as to be displaceable in each of the thickness direction (x-direction), the width direction (Y-direction), and the longitudinal direction (Z-direction) of the male side contact 1.

The inside member 3 is formed into a plate shape of a conductive metal, and has its outer surface having an outer shape similar to an inner shape of the male side contact 1 so as to come into surface contact with an inner surface of the male side contact 1. Both surfaces in the thickness direction at one end of the inside member 3 are respectively provided with recesses 3a that allow each of the male side contact portions 1b to be deformed in the thickness direction of the male side contact 1. Each of the concave portions 3a extends in a direction in which the male side contact portions 1b are arranged (a width direction of the inside member 3). A pair of connection portions 3b connected to the other object to be energized is provided at the other end of the inside member 3.

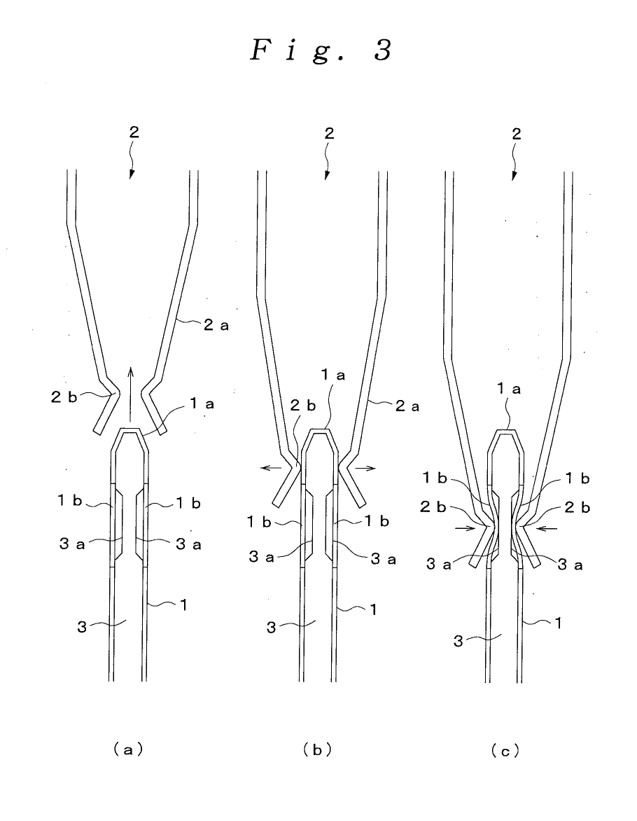

In the electric contact configured as described above, when the male side contact 1 is inserted into the female side contact 2 in the longitudinal direction, as illustrated in FIG. 3 (a), the elastic pieces 2a in the female side contact 2 are elastically deformed outward in a direction to oppose each other by the one end 1a of the male side contact 1, and the female side contact portions 2b move toward the other end of the male side contact 1 while respectively contacting both surfaces in the thickness direction of the male side contact 1, as illustrated in FIG. 3 (b). When the female side contact portions 2b then reach each of the male side contact portions 1b, the male side contact portion 1b is displaced so as to be immersed in the concave portions 3a of the inside member 3 by pressing forces of the female side contact portions 2b, and the female side contact portions 2b engage with the male side contact portion 1b, which has been displaced in the thickness direction of the male side contact 1, so that the male side contact 1 and the female side contacts 2 are connected to each other, as illustrated in FIG. 3 (c).

Thus, in the electric contact according to the present embodiment, when the male side contact 1 is inserted into the female side contact 2, the female side contact portions 2b extending in the width direction of the male side contact 1 press the plurality of male side contact portions 1b arranged in the width direction of the male side contact 1, and each of the male side contact portions 1b is displaced in the thickness direction of the male side contact 1 while contacting the female side contact portions 2b. Therefore, a contact area between the contacts 1 and 2 can be sufficiently ensured. Even if the electric contact is used with a high current, the contacts 1 and 2 can reliably be maintained in a conductive state without generating heat at their contact point. When the contacts 1 and 2 are connected to each other, a feeling of the female side contact portions 2b, together with each of the male side contact portions 1b, being displaced in the thickness direction of the male side contact 1 can be obtained. Therefore, it can be easily confirmed that the male side contact 1 has been inserted into a proper position of the female side contact 2 so that the contacts 1 and 2 can be effectively prevented from being poorly connected to each other due to insufficient insertion. Further, the contacts 1 and 2 engage with each other by the displacement of the contact portions 1b and 2b so that movement of the male side contact 1 in a direction opposite to its insertion direction can be regulated. Therefore, the connection between the contacts 1 and 2 is not easily released, and connection reliability therebetween can also be improved.

The male side contact 1 is formed into a hollow shape, and the inside member 3 having the recesses 3a, which allow each of the male side contact portions 1b to be displaced, is provided in the male side contact 1. Therefore, each of the male side contact portions 1b can be displaced so as to be immersed in the concave portions 3a upon being pressed by the female side contact portions 2b so that only the male side contact portion 1b can be reliably displaced. In this case, the inside member 3 has its outer surface coming into surface contact with an inner surface of the male side contact 1. Therefore, a contact area between the male side contact 1 and the inside member 3 can be sufficiently ensured, so that the male side contact 1 and the inside member 3 can reliably be maintained in a conductive state.

Furthermore, the female side contact 2 has its one end, at which the female side contact portions 2b are provided, displaceable relative to the other end in each of the thickness direction, the width direction, and the longitudinal direction of the male side contact 1. Therefore, a relative shift in position between the contacts 1 and 2 due to vibration and shock can be absorbed, so that a proper connected state can be reliably maintained.

In this case, the plurality of elastic portions 2e, provided in parallel with one another between the fixed portion 2c and the movable portion 2d, is elastically deformed so that one end of the female side contact portion 2b is displaced relative to the other end thereof. Therefore, a cross-sectional area of the elastic portion 2e serving as a conductor can be increased, which can also sufficiently cope with the use of a high current.

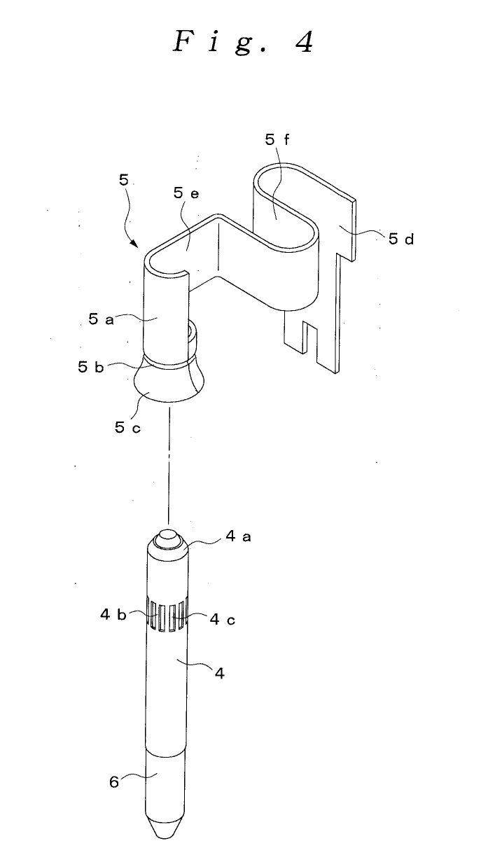

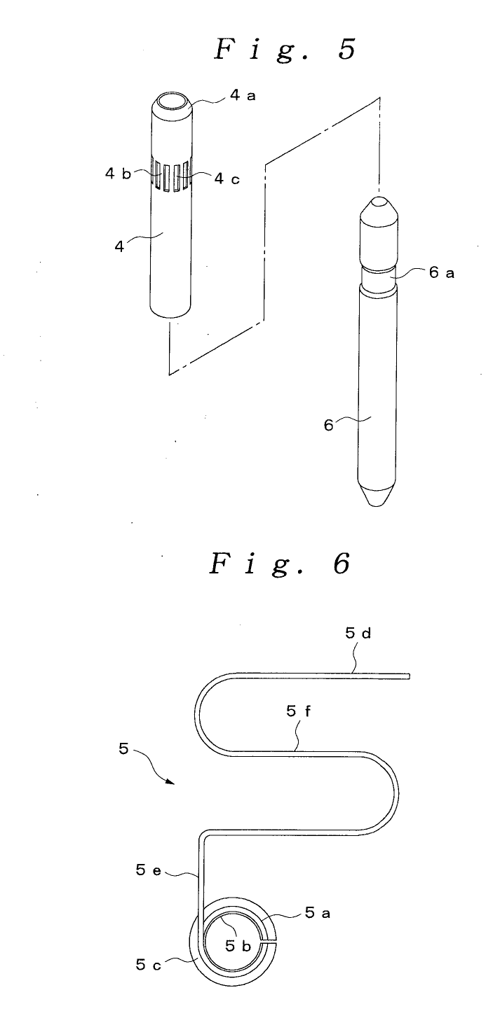

FIGS. 4 to 7 illustrate a second embodiment of the present invention.

An electric contact illustrated in the figures includes a male side contact 4 formed into a cylindrical shape, a female side contact 5 connected to the male side contact 4, and an inside member 6 arranged inside the male side contact 4, and is used for a high-current connector, for example.

The male side contact 4 is formed into a hollow shape by processing a conductive metal plate in a cylindrical shape, and an opening edge at its one end 4a has a tapered shape, the outer diameter of which decreases. A plurality of male side contact portions 4b, which contacts the female side contact 5, is each provided at a predetermined position in the longitudinal direction at one end of the male side contact 4. The male side contact portions 4b are arranged in a direction in which their contact positions with the female side contact 5 are the same in the longitudinal direction of the male side contact 4 (a circumferential direction of the male side contact 4). The male side contact portions 4b are provided among a plurality of long holes 4c extending in the longitudinal direction of the male side contact, and are formed into a strip shape that is deformable in a direction perpendicular to the longitudinal direction of the male side contact 4 (a radial direction of the male side contact 4).

The female side contact 5 is formed by folding a conductive metal plate, and has an elastic piece 5a, which is elastically deformable in the radial direction of the male side contact 4, provided at its one end. The elastic piece 5a is curved to have a cylindrical shape, the inner diameter of which is greater than the outer diameter of the male side contact 4, and is separated at one point in its circumferential direction so that it is elastically deformable in the radial direction. A female side contact portion 5b, which contacts the male side contact 4, is provided on an inner peripheral surface of the elastic piece 5a. The female side contact portion 5b projects toward the inside of the elastic piece 5a, and extends in a direction in which the male side contact portions 4b are arranged (the circumferential direction of the elastic piece 5a). A guide portion 5c for guiding the male side contact 4 inward in the radial direction is provided at a lower end in the figure of the elastic piece 5a. The guide portion 5c has a tapered shape extending outward in the radial direction. The female side contact 5 includes a fixed portion 5d formed at the other end and a movable portion 5e provided with the elastic piece 5a. An elastic portion 5f bent in a U shape is provided between the fixed portion 5d and the movable portion 5e. In this case, the elastic portion 5f is elastically deformed so that the movable portion 5e is displaceable in the radial direction of the male side contact 4.

The inside member 6 is formed into a columnar shape of a conductive metal, and has an outer diameter similar to the inner diameter of the male side contact 4 so that its outer peripheral surface comes into surface contact with an inner peripheral surface of the male side contact 4. In this case, each of both ends of the inside member 6 has a tapered shape, the outer diameter of which decreases. A concave portion 6a, which allows each of the male side contact portions 4b to be deformed in the radial direction of the male side contact 4, is provided at the one end of the inside member 6, and extends in a direction in which the male side contact portions 4b are arranged (a circumferential direction of the inside member 6).

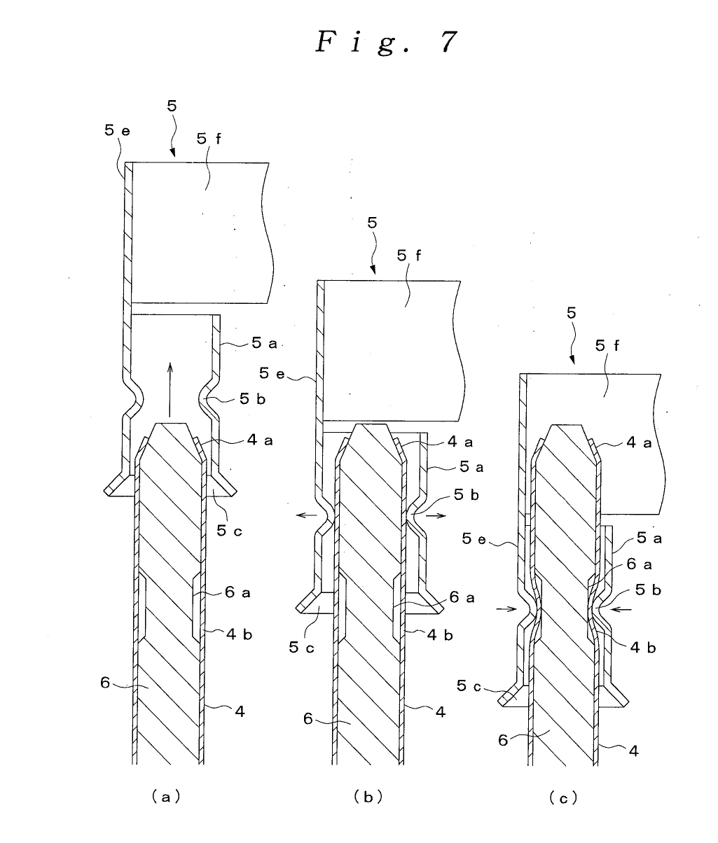

In the electric contact configured as described above, when the male side contact 4 is inserted into the female side contact 5 in the longitudinal direction, as illustrated in FIG. 7 (a), the elastic piece 5a in the female side contact 5 is elastically deformed outward in the radial direction by the one end 4a of the male side contact 4, and the female side contact portion 5b moves toward the other end of the male side contact 4 while contacting an outer peripheral surface of the male side contact 4, as illustrated in FIG. 7 (b). When the female side contact portion 5b then reaches each of the male side contact portions 4b, the male side contact portion 4b is displaced so as to be immersed in the concave portion 6a of the inside member 6 by a pressing force of the female side contact portion 5b, and the female side contact portion 5b engages with the male side contact portion 4b, which has been displaced in the radial direction of the male side contact 4, so that the male side contact 4 and the female side contact 5 are connected to each other, as illustrated in FIG. 7 (c).

Thus, in the electric contact according to the present embodiment, when the male side contact 4 is inserted into the female side contact 5, the female side contact portion 5b extending in the circumferential direction of the male side contact 4 presses the plurality of male side contact portions 4b arranged in the circumferential direction of the male side contact 4, and each of the male side contact portions 4b is displaced in the radial direction of the male side contact 4 while contacting the female side contact portion 5b. Therefore, a contact area between the contacts 4 and 5 can be sufficiently ensured, as in the first embodiment. Even when the electric contact is used with a high current, the contacts 4 and 5 can reliably be maintained in a conductive state without generating heat at their contact point. When the contacts 4 and 5 are connected to each other, a feeling of the female side contact portion 5b, together with each of the male side contact portions 4b, being displaced in the thickness direction of the male side contact 4 can be obtained. Therefore, it can be easily confirmed that the male side contact 4 has been inserted into a proper position of the female side contact 5 so that the contacts 1 and 2 can be effectively prevented from being poorly connected to each other due to insufficient insertion. Further, the contacts 4 and 5 engage with each other by the displacement of the contact portions 4b and 5b so that movement of the male side contact 4 in a direction opposite to its insertion direction can be regulated. Therefore, the connection between the contacts 4 and 5 is not easily released, and connection reliability therebetween can also be improved.

The male side contact 4 is formed into a hollow shape, and the inside member 6 having the concave portion 6a, which allows each of the male side contact portions 4b to be displaced, is provided in the male side contact 4. Therefore, each of the male side contact portions 4b can be displaced so as to be immersed in the concave portion 6a upon being pressed by the female side contact portion 5b so that only the male side contact portion 4b can be reliably displaced. In this case, the inside member 6 has its outer surface coming into surface contact with the inner peripheral surface of the male side contact 4. When the inside member 6 is pressed into the male side contact 4, for example, therefore, a contact area between the male side contact 4 and the inside member 6 can be sufficiently ensured, so that the male side contact 4 and the inside member 6 can reliably be maintained in a conductive state.

Furthermore, the female side contact 5 has its one end, at which the female side contact portion 5b is provided, displaceable relative to the other end in the radial direction of the male side contact 4. Therefore, a relative shift in position between the contacts 4 and 5 due to vibration and shock can be absorbed, so that a proper connected state can be reliably maintained.

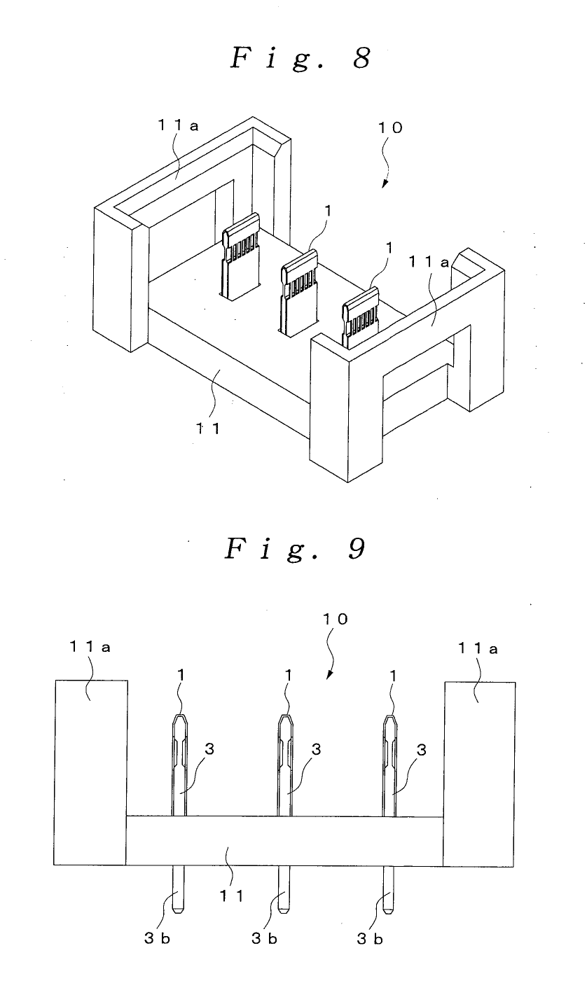

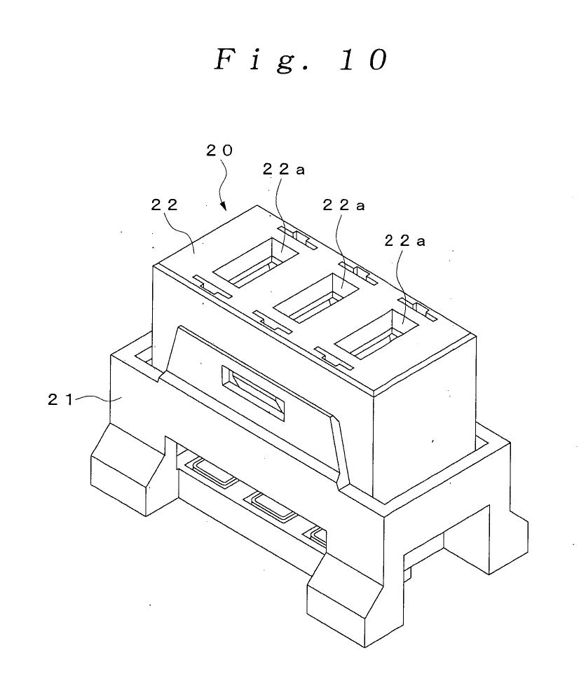

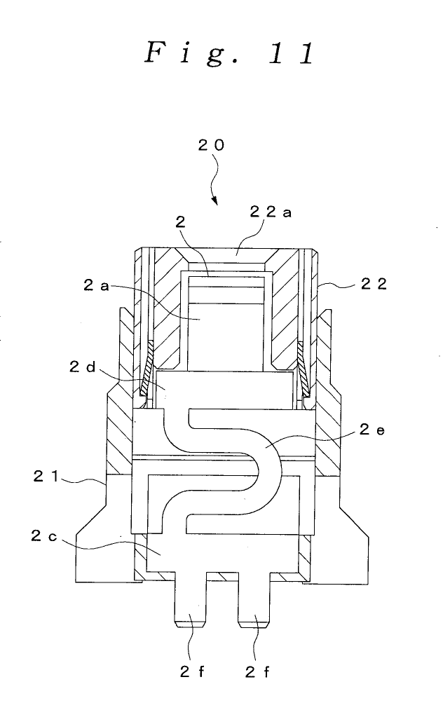

FIGS. 8 to 11 illustrate a connector including the electric contact according to the present invention. Similar components to those in the above-mentioned embodiments are assigned the same reference numerals.

The connector includes a plug 10 including the male side contact 1 according to the first embodiment, and a socket 20 including the female side contact 2 according to the first embodiment. The plug 10 and the socket 20 are fitted to each other so that the male side contact 1 and the female side contact 2 are connected to each other.

The plug 10 includes an insulating plug main body 11, and a plurality of male side contacts 1, spaced apart from one another, is held in the plug main body 11. Sidewall portions 11a are provided on both sides in a width direction of the plug main body 11, and respective connection portions 3b in the male side contacts 1 are arranged to project outward on a lower surface of the plug main body 11.

The socket 20 includes an insulating first socket main body 21, an upper surface of which is opened, and a second socket main body 22 inserted into an opening on the upper surface of the first socket main body 21. A plurality of female side contacts 2, spaced apart from one another, is held in each of the socket main bodies 21 and 22. A fixed portion 2c in each of the female side contacts 2 is fixed to the first socket main body 21, and connection portions 2f in the female side contact 2 are arranged to project outward on a lower surface of the first socket main body 21. A movable portion 2d and an elastic piece 2a in the female side contact 2 are arranged so as to be displaceable in the predetermined direction in the second socket main body 22, and a plurality of insertion holes 22a, into which each of the male side contacts 1 in the plug 10 is inserted, is provided on an upper surface of the second socket main body 22.

In the connector configured as described above, when the plug 10 and the socket 20 are fitted to each other, the male side contact 1 and the female side contact 2 are connected to each other. In the case, a contact area between the contacts 1 and 2 can be sufficiently ensured while a proper insertion position can be easily confirmed, as in the electric contact according to the first embodiment. Further, an effect of not easily releasing the connection can be obtained.

While the connector including the electric contact according to the second embodiment is not illustrated, a similar connector can be configured from a plug including the male side contact 4 according to the second embodiment and a socket including the female side contact 5 according to the second embodiment.

### REFERENCE SIGNS LIST

1 . . . male side contact, 1b . . . male side contact portion, 2 . . . female side contact, 2b . . . female side contact portion, 3 . . . inside member, 3a . . . concave portion, 4 . . . male side contact, 4b . . . male side contact portion, 5 . . . female side contact, 5b . . . female side contact portion, 6 . . . inside member, 6a . . . concave portion, 10 . . . plug, 20 . . . socket.

1. An electric contact having a male side contact and a female side contact and adapted to make a connection between the male side contact and the female side contact in a conductive state by inserting the male side contact into the female side contact in its longitudinal direction, wherein the electric contact comprises:
a plurality of male side contact portions each provided at a predetermined position in the longitudinal direction of the male side contact so as to be deformable in a direction perpendicular to the longitudinal direction of the male side contact and arranged so that their contact positions with the female side contact are the same in the longitudinal direction of the male side contact; and
a female side contact portion provided in the female side contact so as to be elastically deformable in a direction perpendicular to the longitudinal direction of the male side contact and extending in a direction in which the male side contact portions are arranged, and
in that when the male side contact is inserted into the female side contact, each of the male side contact portions is displaced in the direction perpendicular to the longitudinal direction of the male side contact upon being pressed by the female side contact portion.

2. The electric contact according to claim 1, wherein
the male side contact is formed into a hollow shape, and
the male side contact is provided with an inside member having a concave portion that allows each of the male side contact portions to be displaced.

3. The electric contact according to claim 1, wherein
the male side contact is formed into a plate shape, and
the female side contact is provided with a pair of elastic pieces, each having the female side contact portion extending in a width direction of the male side contact, the elastic pieces being elastically deformable in a thickness direction of the male side contact.

4. The electric contact according to claim 1, wherein
the male side contact is formed into a columnar shape, and
the female side contact is provided with a cylindrical elastic piece, having the female side contact portion extending in a circumferential direction of the male side contact, the elastic piece being elastically deformable in a radial direction of the male side contact.

5. The electric contact according to claim 1, wherein
one of the male side contact and the female side contact has its one end, at which the contact portion is provided, displaceable in a predetermined direction relative to the other end.

6. The electric contact according to claim 5, wherein
one of the male side contact and the female side contact has its one end, at which the contact portion is provided, displaced relative to the other end by a plurality of elastic portions provided in parallel with one another between the one end and the other end.

7. A connector, comprising an electric contact according to claim 1.
